(19) United States
(12) Patent Application Publication
(10) Pub. No.: US 2007/0249511 A1
(43) Pub. Date: Oct. 25, 2007

(54) Bleach particle

(75) Inventors: Nigel Patrick Somerville Roberts, Newcastle/Tyne (GB); Vincenzo Guida, Rome (IT); Christopher Charles Graham, Newcastle/Tyne (GB); Giulia Ottavia Bianchetti, Rome (IT)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/788,068

(22) Filed: Apr. 19, 2007

(30) Foreign Application Priority Data
Apr. 20, 2006 (EP) 06112838.5

(51) Int. Cl. C11D 3/00

(52) U.S. Cl. 510/375

(57) ABSTRACT

A bleach particle comprising:
i) at least above about 50% by weight thereof of diacyl and/or tetraacyl peroxide bleaching species selected from diacyl peroxides of the general formula:

R¹—C(O)—OO—(O)C—R²

in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:

R³—C(O)—OO—C(O)—(CH₂)n-C(O)—OO—C(O)—R³

in which R³ represents a C₁-C₉ alkyl group and n represents an integer from 2 to 12; and
ii) from about 0.1% to about 10% by weight thereof of a radical scavenger.

### TECHNICAL FIELD

The present invention relates to a bleach particle comprising diacyl and/or tetraacyl peroxide bleaching species and an anti-oxidant. The particle comprises a high level of the bleaching species and has improved stability, formulation compatibility and bleaching performance.

### BACKGROUND OF THE INVENTION

A problem found in the field of dishwashing, and in particular automatic dishwashing, is the removal of coloured stains from dishware/tableware, in particular from plastic substrates which have been in contact with coloured foods. In addition, the coloured material when removed or partially removed from the stained substrate can deposit on the plastic parts of the automatic dishwashing machine.

Different solutions have been proposed to tackle the removal and deposition of coloured stains from plastic in a machine dishwashing method. WO 03/095598 relates to a process for removing coloured stains from plastic by treating the substrate in an ADW machine with an aqueous liquor having a peroxide value of 0.05 to 40 (peroxide components include terpenes). In WO 03/095599 the coloured stains from plastic are removed by treating the substrate with a composition comprising 3-phenyl-2-propenal and/or 3,7-dimethyl-2,6-octadien-1-al. WO 03/095602 presents another alternative process for removing coloured stains from plastic by treating the substrate with an aqueous composition comprising a hydrophobic component having a density in the range of 0.06 to 1 gram/cm3. Hydrophobic components include hydrocarbon oil and edible oil. Paraffin oil is the preferred hydrophobic component.

Diacyl and/or tetraacyl peroxide bleaching species may be used to inhibit the transfer of coloured/bleachable soils when employed in a laundry (WO 93/07086) or dishwashing (WO 95/19132) method. Such species are however intrinsically unstable above their melting points and are liable to self-accelerating thermal decomposition. To provide storage stability '086 and '132 propose the incorporation of the diacyl and tetraacyl bleaching species as “guest” molecules in “host-guest complexes” in which the molecules of the bleaching species are individually separated from each other by their inclusion in the host receptor sites. The hosts may for example be inorganic or organic crystals having relatively open structures which provide sites that may be occupied by guest molecules, thus forming the host-guest complexes. Examples of suitable hosts include certain clathrates or inclusion compounds, including the urea clathrates and the cyclodextrins, particularly the beta-cyclodextrins. The hosts are most preferably water soluble, to enable effective release and dispersion of the bleaching species on introduction of the host-bleaching species complexes into an aqueous media, such as a wash solution. Urea clathrates of diacyl and tetraacyl bleaching species have been disclosed in both WO 93/07086 and WO 95/19132.

There is the need for more flexible forms comprising diacyl and/or tetraacyl peroxide bleaching species which have improved thermal, chemical and in product stability. Additionally, there is the need for particles which do not segregate in detergent products.

### SUMMARY OF THE INVENTION

According to the first aspect of the invention there is provided a bleach particle comprising at least above about 50%, preferably at least above about 55%, more preferably at least above about 60% and specially preferred above about 65% by weight thereof of diacyl and/or tetraacyl peroxide bleaching species selected from diacyl peroxides of the general formula:

R¹—C(O)—OO—(O)C—R²

in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:

R³—C(O)—OO—C(O)—(CH₂)n-C(O)—OO—C(O)—R³

in which R³ represents a C₁-C₉ alkyl group and n represents an integer from 2 to 12.

The bleaching species of the particle of the invention provide excellent coloured stain removal from dishware/tableware in an automatic dishwashing process, as well as avoid re-deposition issues. Different kinds of acyl peroxides have different physical and chemical properties. Acyl peroxides having aromatic groups, such as dibenzoyl peroxide, are usually insoluble in water and although they can provide stain removal benefits they might leave residues on the washed articles, in particular when the acyl peroxide particles have a large size (400-700 μm). The prior art (U.S. Pat. No. 5,763,378) envisages the use of diacyl peroxide particles having small primary particle size (less than 300 μm). These primary particles are incorporated into larger secondary particles. The level of actives of the secondary particles is low, due to the presence of carrier material. The particles of the invention have a high level of active bleaching species. Acyl peroxides having aromatic groups usually have a higher melting point and are chemically and thermally more stable than those having aliphatic groups. The bleaching species of the particles of the present invention usually melt at the dishwashing wash temperature. The bleaching species of the particles of the invention are very instable and have a relative low melting temperature (about 54-55° C.) and an even lower self decomposition temperature.

In preferred embodiments the bleaching species is selected from diacyl peroxides in which R1 and R2 are C₈-C₁₂ aliphatic groups, more preferably R1 and R2 are C11, i.e., dilauroyl peroxide. Dilauroyl peroxide provides excellent coloured stain removal, in particular from plastic substrates, as well as anti-redeposition benefits.

The bleach particle preferably comprises from about 0.01% to about 10%, more preferably from about 0.1% to about 7% and especially from about 0.2% to about 2% by weight of the particle of radical scavenger. It has surprisingly being found that a radical scavenger level above about 10% negatively affects the stability of the bleach particle. The particle of the invention presents a high level of stability.

Without wishing to be bound by theory, it is believed that there are three main mechanisms that affect the stability of the bleaching species: thermal decomposition, radical induced decomposition and hydrolysis/perhydrolysis. All of them seem to generate free radicals that contribute to the self decomposition of the bleaching species. It has now been found that the presence of radical scavengers in the bleach particle contributes to improve the stability of the bleaching species in the bleach particle and of the bleach particle in a detergent composition. The instability of the bleach particle within a detergent composition can, inter alia, be generated by free moisture, alkalinity, acidity or the interaction with other ingredients, such as: i) other bleaches (for example percarbonate); ii) surfactants, in particular alkoxylated surfactants; iii) metal cations, which can be part of a bleach catalyst or be present in the detergent as contaminants, etc.

The bleach particle of the invention is white when freshly make. It has been noticed that the particle can become off white or even yellow with time. This change of colour can be avoided when using an alkoxylated benzoic acid or salts thereof and in particular 3,4,5,-trimethoxy benzoic acid. Thus, according to a preferred embodiment of the invention the bleach particle comprises an alkoxylated benzoic acid or salts thereof.

Detergent compositions, in particular automatic dishwashing compositions, are usually alkaline, this negatively impacts on the stability of the bleach particle. It has been found that the presence of an acid improves the stability of a bleach particle in an alkaline detergent composition. Thus, there is provided a bleach particle comprising at least above about 50%, preferably at least above about 55%, more preferably at least above about 60% and especially preferred above about 65% by weight thereof of the diacyl and/or tetraacyl peroxide bleaching species described hereinabove and an acid. Preferably, the acid should not be detrimental for the dissolution of the particle, more preferably the acid should improve the dissolution of the particle. Preferred for use herein is citric acid, in particular anhydrous citric acid.

Equally, the presence of an alkali in the bleach particle might improve its stability in an acidic detergent composition.

It has been found that the stability of the bleach particle can be further improved by adding a buffering agent to the particle. Thus, in preferred embodiments, the bleach particle comprises an acid and a buffering agent, to resist the changes of pH within the bleach particle. Preferably the buffering agent is the alkaline salt, more preferably the sodium salt of the corresponding acid. Preferred buffering agent for use herein is tri-sodium citrate.

In a highly preferred embodiment, the particle of the invention comprises the bleaching species, a radical scavenger, an acid and a buffer agent. A particle having this composition has been found extremely stable, even under extreme conditions.

The bleaching species of the present invention is usually in flake form, having a waxy consistency, it does not seem to be very strong mechanically. In order to enhance the handability and mechanical properties of the particle a strengthening agent can be added to the particle of the invention. Silica is the preferred strengthening agent for use herein.

Additionally the bleach particle may comprise a solubilising agent, i.e., an agent that improves the solubility of the particle and therefore the dispersability of the bleaching species.

According to another aspect of the invention, there is provided a detergent or a bleaching composition comprising the bleach particle of the invention. In particular, the detergent composition is an automatic dishwashing detergent composition.

Colour stains are mainly caused by soils which contain tomato soils, such as lasagne, carotene soils, such as cooked carrots (also known as lycopene soils), curry sauce and mixtures thereof. These stains are particularly difficult to remove from hydrophobic surfaces, such as plastic. The cleaning is more difficult in the presence of soil in the dishwasher. Compositions capable of removing colour stains in the absence of other soils do not seem to be capable of achieving similar degree of removal in the presence of soils (as is the case in a normal dishwashing load), this effect is more acute in the case of dishwashing loads containing a high level of greasy/oily soils. Satisfactory stain removal may not be achieved even with relatively high levels of the bleaching species. Improved coloured stain removal is achieved with the compositions of the invention.

There is also provided a method of removing colour stains from a hydrophobic substrate, preferably plastic, in an automatic dishwashing machine, using the particles of the invention. The method comprises the step of washing the substrate in an automatic dishwashing machine in the presence of the detergent or bleaching composition of the invention.

### DETAILED DESCRIPTION OF THE INVENTION

The present invention relates to a bleach particle having a high level of certain diacyl/tetraacyl bleaching species. The particle preferably comprises a low level of radical scavenger. The particle of the invention presents improved stability when placed in a detergent composition. The invention also envisages embodiments in which the particle comprises an acid, and the combination of an acid and a buffering agent. Other optional components of the particle include strengthening agents and solubilising agents.

The particle of the invention is particularly suitable for introduction in detergent compositions, especially in automatic dishwashing detergent compositions, thereby providing excellent soil removal of coloured stains from cookware/tableware, in particular from plastic substrates. The particle of the invention is also suitable for use in a laundry detergent.

### Diacyl and Tetraacyl Peroxide Bleaching Species

The diacyl peroxide bleaching species is selected from diacyl peroxides of the general formula:

R¹—C(O)—OO—(O)C—R²

in which R¹ represents a C₆-C₁₈ alkyl, preferably C₆-C₁₂ alkyl group containing a linear chain of at least 5 carbon atoms and optionally containing one or more substituents (e.g.—N⁺(CH₃)₃, —COOH or —CN) and/or one or more interrupting moieties (e.g.—CONH— or —CH═CH—) interpolated between adjacent carbon atoms of the alkyl radical, and R² represents an aliphatic group compatible with a peroxide moiety, such that R¹ and R² together contain a total of 8 to 30 carbon atoms. In one preferred aspect R¹ and R² are linear unsubstituted C₆-C₁₂ alkyl chains. Most preferably R¹ and R² are identical. Diacyl peroxides, in which both R¹ and R² are C₆-C₁₂ alkyl groups, are particularly preferred. The tetraacyl peroxide bleaching species is selected from tetraacyl peroxides of the general formula:

R³—C(O)—OO—C(O)—(CH₂)n-C(O)—OO—C(O)—R³

in which R³ represents a C₁-C₉ alkyl, preferably C₃-C₇, group and n represents an integer from 2 to 12, preferably 4 to 10 inclusive.

Preferably the bleaching species is a diacyl peroxide wherein R¹ and R² are both the same or different C₆-C₁₂ unsubstituted alkyl group, more preferred for use herein are diacyl peroxide wherein both is R¹ and R² are C8, C9, C10 or C11. Dilauroyl peroxide is specially preferred for use herein, in particular for its performance in an automatic dishwashing operation.

Preferably, the bleaching species of the invention are in the form of flakes before they are introduced in the bleach particle. The particle of the invention has high level of bleaching species, at least 50%, preferably at least 60%, more preferably at least 70% and especially at least 80% by weight thereof. The particle preferably comprises low level (i.e., less that 10%, preferably less than 5% by weight of the particle) of inactive cleaning materials, i.e., material that contributes to the processability of the particle but do not play a role in the cleaning process, such as carrier materials (for example, zeolites, polyethylene glycols, waxes, etc).

Suitable acyl peroxides for use in the particle of the invention are available from Degussa.

### Radical Scavenger

It is believed that radical scavengers trap or scavenge radicals formed due to decomposition of the peroxide bond. This would prevent the radical from further reacting or propagating the formation of another radical (self-accelerated decomposition). Radical scavengers further contribute to the stability of detergent compositions when the bleach particle is placed therein. The stability of detergent compositions upon storage, comprising the particle of the invention, has been found to be excellent.

Suitable radical scavengers for use herein include substituted mono- and di-hydroxy benzenes and derivatives thereof, alkyl- and aryl carboxylates and mixtures thereof. Preferred radical scavengers for use herein include di-tert-butyl hydroxy toluene (BHT), p-hydroxy-toluene, hydroquinone (HQ), di-tert-butyl hydroquinone (DTBHQ), mono-tert-butyl hydroquinone (MTBHQ), tert-butyl-hydroxy anysole (BHA), p-hydroxy-anysol, benzoic acid, 2,5-dihydroxy benzoic acid, 2,5-dihydroxyterephtalic acid, toluic acid, catechol, t-butyl catechol, 4-allyl-catechol, 4-acetyl catechol, 2-methoxyphenol, 2-ethoxy-phenol, 2-methoxy-4-(2-propenyl)phenol, 3,4-dihydroxy benzaldehyde, 2,3-dihydroxy benzaldehyde, benzylamine, 1,1,3-tris(2-methyl-4-hydroxy-5-t-butylphenyl)butane, tert-butyl-hydroxy-anyline, p-hydroxy anyline as well as n-propyl-gallate. Highly preferred for use herein is di-tert-butyl hydroxy toluene, which is for example commercially available from SHELL under the trade name IONOL CP® and/or tert-butyl-hydroxy anysole and/or propyl gallate.

Especially suitable for use in the particle of the invention is an alkoxylated benzoic acid or salts thereof having the general formula:

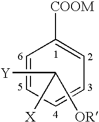

wherein: the substituents of the benzene ring X and Y are independently selected from—H, or —OR′; R′ is independently selected from C to C₂₀ linear or branched alkyl chains, preferably R′ is independently selected from C₁ to C₅ linear or branched alkyl chains, more preferably R′ is —CH₃, and; M is hydrogen, a cation or a cationic moiety. Preferably, M is selected from the group consisting of hydrogen, alkali metal ions and alkaline earth metal ions. More preferably, M is selected from the group consisting of hydrogen, sodium and potassium. Even more preferably, M is hydrogen.

Said alkoxylated benzoic acid or the salt thereof can be a monoalkoxy benzoic acid or a salt thereof, wherein in the above general formula the substituents of the benzene ring X and Y are —H; R′ is independently selected from C₁ to C₂₀ linear or branched alkyl chains, preferably R′ is independently selected from C₁ to C₅ linear or branched alkyl chains, more preferably R′ is —CH₃, and; M is hydrogen, a cation or a cationic moiety. Preferably, said monoalkoxy benzoic acid or a salt thereof is selected from the group consisting of o-/m-/p-methoxy benzoic acids, salts thereof, and mixtures thereof. More preferably, said monoalkoxy benzoic acid or a salt thereof is m-methoxy benzoic acid (wherein the methoxy group is in position 3 in the above general formula) or a salt thereof. Said alkoxylated benzoic acid or the salt thereof can be a dialkoxy benzoic acid or a salt thereof, wherein in the above general formula: the substituent of the benzene ring X is selected from —H; the substituent of the benzene ring Y is —OR′; R′ is independently selected from C₁ to C₂₀ linear or branched alkyl chains, preferably R′ is independently selected from C₁ to C₅ linear or branched alkyl chains, more preferably R′ is —CH₃, and; M is hydrogen, a cation or a cationic moiety.

Said alkoxylated benzoic acid or the salt thereof can be a trialkoxy benzoic acid or a salt thereof, wherein in the above general formula: the substituents of the benzene ring Y and X are —OR′; R′is independently selected from C₁ to C₂₀ linear or branched alkyl chains, preferably R′ is independently selected from C₁ to C₅ linear or branched alkyl chains, more preferably R′ is —CH₃, and; M is hydrogen, a cation or a cationic moiety.

In a highly preferred embodiment of the present invention, said alkoxylated benzoic acid or the salt thereof is a trimethoxy benzoic acid or a salt thereof (TMBA), wherein in the above general formula the substituents of the benzene ring Y and X are —OR′; R′ is —CH₃ and; M is hydrogen, a cation or a cationic moiety. Preferably, said alkoxylated benzoic acid or the salt thereof is selected from the group consisting of 3,4,5,-trimethoxy benzoic acid, a salt thereof, 2,3,4-trimethoxy benzoic acid, a salt thereof, 2,4,5-trimethoxy benzoic acid, a salt thereof and a mixture thereof. More preferably, said alkoxylated benzoic acid or the salt thereof is 3,4,5,-trimethoxy benzoic acid or a salt thereof. Even more preferably, said alkoxylated benzoic acid or the salt thereof is 3,4,5,-trimethoxy benzoic acid.

Suitable monoalkoxy benzoic acids or salts thereof are commercially available from Aldrich, in particular m-methoxy benzoic acid is commercially available from Aldrich. Suitable trimethoxy benzoic acids or salts thereof are commercially available from Aldrich and Merck.

### Acid

Preferred acids for use herein include water-soluble organic mono- and polycarboxylic acids with two to six carbon atoms in the molecule and optionally substituted by one or more hydroxy groups. Suitable classes include alkanoic acids, hydroxyalkanioc acids, alkyl polycarboxylic acids and hydroxyalkyl polycarboxylic acids. Preferred herein are mono- and polycarboxylic acids which have a pKa value, related to the first dissociation stage (pKa₁) of no more than about 6. These include for example, adipic acid, succinic acid, tartaric acid, malic acid, maleic acid, glutaric acid, citric acid and mixtures thereof. Especially preferred for use in the particle of the invention is citric acid.

Inorganic acids and mixtures of inorganic acids and organic acids can also be used herein. Examples of inorganic acids are sulphonic acid derivatives, sulphamic acid (pKa=0.1), hydrochloric acid (pKa<0), nitric acid (pKa<0), phosphoric acid (pKa=2.1) and sulphuric acid (pKa=0.4). Suitable sulphonic acid derivatives include alkyl sulphonic acids and aryl sulphonic acids. Suitable alkyl sulphonic acids include C1-C6 linear or branched alkylsulphonic acids or mixtures thereof, such as methanesulphonic acid (pKa=1.9) commercially available for example from Aldrich, William Blythe & Co. Ltd. or Elf. Atochem. Suitable aryl sulphonic acids for use herein include those of the formula:

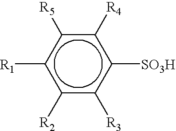

wherein R1, R2, R3, R4 and R5 are each H or SO₃H, or linear or branched C1-C4 alkyl chain; or mixtures thereof, the total number of C₁-C₄ alkyl chains preferably being no more than 2.

Preferred arylsulphonic acids to be used are those which comprise no or only one alkyl chain. Particularly suitable arylsulphonic acids for use herein are benzene sulphonic acid (pKa=0.7), toluene sulphonic acid and cumene sulphonic acid.

Preferably, the acid (or acids) is used in its lower hydration form, more preferably in anhydrous form, for stability reasons. Weak acids, i.e., acids with a pKa greater than about 1, are preferred for use herein.

Specially preferred for use herein is citric acid in granulated form, in particular anhydrous citric acid having a mean particle size (by weight) of less than about 300 μm, more preferably less than 280 μm. Especially preferred is citric acid having a mean particle size of about 250 μm.

The acid, if present in the particle of the invention, is typically incorporated at a level of from about 0.1% to about 20%, preferably from about 0.5 to about 15% and more preferably from about 1 to about 12% by weight of the particle.

### Buffering Agent

It has been found highly beneficial to include in the bleach particle a pH buffering agent, preferably sodium citrate, which may be used in combination with an acid, preferably citric acid, to combat pH drift which might occur upon storage of the particle in a detergent composition.

Buffers are conventionally composed of weak acids and bases, which do not completely ionize in solution. A combination of sodium citrate and citric acid is the preferred buffer for the present invention, due to the presence of three carbonyl groups, resulting in three different pKa values.

The buffering agent, if present in the particle of the invention, is typically incorporated at a level of from about 0.1% to about 20%, preferably from about 0.5 to about 15% and more preferably from about 1 to about 12% by weight of the particle.

### Strengthening Agent

The particle of the invention might also comprise agents for improving the mechanical properties of the particle. Strengthening agents are usually in powder form. Preferred examples of strengthening agents are silica, talc, diatomaceous earth, chitosan, etc.

The strengthening agent, if present in the particle of the invention, is typically incorporated at a level of from about 0.1% to about 20%, preferably from about 0.5 to about 15% and more preferably from about 1 to about 12% by weight of the particle.

### Solubilising Agent

By “solubilising agent” herein is meant an agent that improves the solubility/dispersability of the particles comprising bleaching species into the wash solution as compared to a particle free of the solubilising agent. For example, whether a particle component is a solubilising agent can be assessed by introducing a certain weight of particles with and without the solubilising agent, for example 1 gram, in a certain volume of water, for example 250 ml, at 40° C. The water is stirred with for example a magnetic stirrer, at 250 rpm. The two solutions (water and particles with and without solubilising agent) are filtered (using identical filters) after certain time, for example 5 minutes, preferably 1 minute and even more preferably 30 seconds, the filters are dried and weighted, if the weight of the filter used for filtering the solution comprising the particles with the solubilising agent is less than 5%, preferably less than 10% and more preferably less than 15% than the way of the filter used for filtering the solution comprising the particles without the solubilising agent, then the agent would be classified as solubilising agent. The filter is chosen taken into account the size of the particles, the aperture size of the filter should be less than 5%, preferably less than 10% and more preferably less than 15% of the diameter of the tested particles. The skilled person would know how to chose the right filter to evaluate if a material can be considered a solubilising agent.

A solubilising material can also be defined as that having a solubility in water at 25° C. of at least 20 grams, preferably 25 grams and more preferably 40 grams per 100 grams of water.

Examples of solubilising agents include highly water soluble salts such as sodium citrate dehydrate, potassium carbonate, urea, sodium acetate (anhydrous), sodium acetate trihydrate, magnesium sulphate 7H20, potassium acetate and mixtures thereof. Preferred for use herein as solubilising agent is urea.

A buffering agent can also act as a solubilising agent. The solubilising agent, if present in the particle of the invention, is typically incorporated at a level of from about 0.1% to about 20%, preferably from about 0.5 to about 15% and more preferably from about 1 to about 12% by weight of the particle.

The present invention also relates to detergent and bleaching compositions comprising the diacyl and/or tetraacyl bleach particles. The compositions are preferably in solid or unit dose form, eg in powder, tablet or pouch form but can also be in liquid form. Liquid type compositions include formulations in which the liquid does not react with the bleaching species, such as anhydrous formulations. The detergent compositions are particularly useful for the removal of colour stains from hydrophobic substrates in an automatic dishwashing process in the presence of high soils. The bleaching composition can be used as additives, in combination with other detergent compositions or by themselves.

The detergent and bleaching compositions herein comprise traditional detergency components. The compositions, especially the detergent compositions, will generally be built and comprise one or more detergent active components which may be selected from colorants, additional bleaching agents, surfactants, alkalinity sources, enzymes, anti-corrosion agents (e.g. sodium silicate) and disrupting agents (in the case of powder, granules or tablets). Highly preferred detergent components include a builder compound, an alkalinity source, a surfactant, an enzyme and an additional bleaching agent. Preferably, the compositions of the invention comprise an additional bleaching agent in addition to the diacyl and/or tetraacyl peroxide. Preferably the additional bleaching agent is a percarbonate, in a level of from about 1% to about 80% by weight of the composition, in the case of a detergent composition the level is from about 2% to about 40%, more preferably from about 3% to about 30% by weight of the composition.

### Co-Bleaching Surfactant

The compositions of the invention may comprise a “co-bleaching surfactant” i.e, a surfactant which helps the diacyl and/or tetraacyl bleaching species to perform its bleaching function. The ethoxylated alcohols surfactants for use herein are essentially free of alkoxy groups other than ethoxy groups.

The co-bleaching surfactant can be a single surfactant or a mixture thereof, preferably including one or more co-bleaching surfactants having a cloud point above wash temperature ie, preferably above about 40° C., more preferably above about 50° C. and even more preferably above about 60° C. “Cloud point”, as used herein, is a well known property of surfactants and mixtures thereof which is the result of the surfactant becoming less soluble with increasing temperature, the temperature at which the appearance of a second phase is observable is referred to as the “cloud point” (See KirkOthmer's Encyclopedia of Chemical Technology, 3rd Ed., Vol. 22, pp. 360-362).

Preferred co-bleaching surfactants for use herein include both liner and branched alkyl ethoxylated condensation products of aliphatic alcohols with an average of from about 4 to about 10, preferably form about 5 to about 8 moles of ethylene oxide per mol of alcohol are suitable for use herein. The alkyl chain of the aliphatic alcohol generally contains from about 6 to about 15, preferably from about 8 to about 14 carbon atoms. Particularly preferred are the condensation products of alcohols having an alkyl group containing from about 8 to about 13 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be less than about 18, preferably less than about 15 and even more less than 14. Preferably, the surfactant is substantially free of propoxy groups. Commercially available products for use herein include Lutensol®TO series, C13 oxo alcohol ethoxylated, supplied by BASF, especially suitable for use herein being Lutensol®TO7.

Amine oxides surfactants are also useful in the present invention and include linear and branched compounds having the formula:

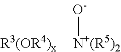

wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C10-8 acylamido alkyl dimethylamine oxide.

### Suds Suppresser

The compositions of the invention may comprise suds suppresser. Surfactants for use as suds suppressers are preferably non-ionic surfactants having a low cloud point. As used herein, a “low cloud point” non-ionic surfactant is defined as a non-ionic surfactant system ingredient having a cloud point of less than 30° C., preferably less than about 20° C., and even more preferably less than about 10° C., and most preferably less than about 7.5° C. Typical low cloud point non-ionic surfactants include non-ionic alkoxylated surfactants, especially ethoxylates derived from primary alcohol, and polyoxypropylene/polyoxyethylene/polyoxypropylene (PO/EO/PO) reverse block polymers. Also, such low cloud point non-ionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of non-ionics, as described, for example, in U.S. Pat. No. 5,576,281).

Other suitable low cloud point surfactants are the ether-capped poly(oxyalkylated) suds suppresser having the formula:

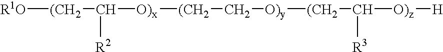

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point non-ionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II}, may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

If non-ionic suds suppressers are used they are preferably used in a level of from about 5% to about 40%, preferably from about 8% to about 35% and more preferably form about 10% to about 25% by weight of the composition.

The co-bleaching surfactant, if used, is preferably used in the compositions of the invention at a level of from about 2% to about 30%, more preferably from about 4% to about 25% and even more preferably form about 3% to about 20% by weight of the composition. It is also preferred that the ethoxylated alcohols, the amine oxide surfactants and the mixtures thereof are in a level of at least about 2%, more preferably about 3% by weight of the composition. In preferred embodiments the ethoxylated alcohols are in a level above about 3%, more preferably above about 4% by weight of the composition.

### EXAMPLES

BHT, sodium sulphate, sodium citrate were milled to have a particle size below 250 μm. The particle size of the dilauryl peroxide was below 450 μm. Granules having the compositions showed in table I where made by compaction of the compositions A to D.

TABLE 1

| | A (% wt) | B (% wt) | C (% wt) | D (% wt) |
|---|---|---|---|---|
| Dilauryl peroxide | 98.25 | 79 | 79 | 79 |
| BHT | 0.75 | 1 | 1 | 1 |
| Sodium sulphate | | 10 | | |
| Sodium citrate | | 10 | 10 | 10 |
| Citric acid | | | 10 | 10 |
| Silica | 1 | | | |

The dimensions and values disclosed herein are not to be understood as being strictly limited to the exact numerical values recited. Instead, unless otherwise specified, each such dimension is intended to mean both the recited value and a functionally equivalent range surround that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A bleach particle comprising:
(A) at least about 50% by weight thereof of a bleach selected from the group consisting of:
(1) diacyl peroxide of the general formula:
R¹—C(O)—OO—(O)C—R²
where R¹ represents a C₆-C₁₈ alkyl group and R² represents an aliphatic group compatible with a peroxide moiety, such that R¹ and R² together contain a total of 8 to 30 carbon atoms;
(2) tetraacyl peroxide of the general formula:
R³—C(O)—OO—C(O)—(CH₂)ₙ—C(O)—OO—C(O)—R³
where R³ represents a C₁-C₉ alkyl group and n represents an integer from 2 to 12; and
(3) mixtures thereof;
(B) from about 0.1% to about 10% by weight thereof of a radical scavenger;
(C) from about 0.1% to about 20% by weight thereof of an acid;
(D) from about 0.1% to about 20% by weight thereof of a buffering agent.

2. A bleach particle according to claim 1 wherein the bleach is a diacyl peroxide where R¹ is a C₈-C₁₂ alkyl group and R² is a C₈-C₁₂ aliphatic group compatible with a peroxide moiety.

3. A bleach particle according to claim 1 wherein the bleach particle further comprises a strengthening agent, a solubilizing agent and mixtures thereof.

4. A bleach particle according to claim 1 wherein the radical scavenger is selected from substituted mono- and di-hydroxy benzenes, mono- and di-hydroxy benzenes derivatives, alkyl-carboxylates, aryl carboxylates and mixtures thereof.

5. A bleach particle according to claim 1 wherein the radical scavenger is selected from di-tert-butyl hydroxy toluene, p-hydroxy-toluene, hydroquinone, di-tert-butyl hydroquinone, mono-tert-butyl hydroquinone, ter-butyl-hydroxy anysole, p-hydroxy-anysol, benzoic acid, 2,5-dihydroxy benzoic acid, 2,5-dihydroxyterephtalic acid, toluic acid, catechol, t-butyl catechol, 4-allyl-catechol, 4-acetyl catechol, 2-methoxyphenol, 2-ethoxy-phenol, 2-methoxy-4-(2-propenyl)phenol, 3,4-dihydroxy benzaldehyde, 2,3-dihydroxy benzaldehyde, benzylamine, 1,1,3-tris(2(methyl-4-hydroxy-5-t-butylpenyl)butane, tert-butyl-hydroxy-anyline, p-hydroxy anyline, and n-propyl-gallate.

6. A bleach particle according to claim 1 wherein the acid is selected from the group comprising water soluble organic mono- and polycarboxylic acids with 2 to 6 carbon atoms and optionally substituted by one or more hydroxy groups, inorganic acids and mixtures thereof.

7. A bleach particle according to claim 6 wherein the acid is selected from the group consisting of adipic acid, succinic acid, tartaric acid, malic acid, maleic acid, glutaric acid, citric acid and mixtures thereof.

8. A bleach particle according to claim 7 wherein citric acid is anhydrous and comprises a mean particle size by weight of less than about 300 μm.

9. A bleach particle according to claim 1 wherein the buffering agent comprising three carbonyl groups.

10. A bleach particle according to claim 9 wherein the buffering agent is sodium citrate.

11. A bleach particle of claim 3 wherein the strengthening agent is selected from the group consisting of: silica, talc, diatomaceous earth and chitosan.

12. A bleach particle of claim 3 wherein the solubilizing agent is selected from the group consisting of: sodium citrate dehydrate, potassium carbonate, urea, sodium acetate anhydrous, sodium acetate trihydrate, magnesium sulphate, potassium acetate and mixtures thereof.

13. A detergent or bleaching composition comprising a bleach particle according to claim 1.
